(19) United States
(12) Patent Application Publication
(10) Pub. No.: US 2023/0344928 A1
(43) Pub. Date: Oct. 26, 2023

(54) Wireless In-Line Dock for Headsets

(71) Applicant: Plantronics, Inc., Santa Cruz, CA (US)

(72) Inventor: Hytham Alihassan, Austin, TX (US)

(73) Assignee: Plantronics, Inc., Santa Cruz, CA (US)

(21) Appl. No.: 17/724,843

(22) Filed: Apr. 20, 2022

(51) Int. Cl. H04M 1/60; H04R 1/10; G06F 3/16

(52) U.S. Cl. CPC H04M 1/6066; H04R 1/1041; G06F 3/165; G06F 3/162; H04R 2420/07

(57) ABSTRACT

Methods and apparatuses for headset control and interfaces are described. In one example, an in-line dock includes a host interface for connection to a host device to transfer digital data between the apparatus and the host device, a cable connector interface, one or more user interfaces, and a radio transceiver.

### BACKGROUND OF THE INVENTION

Numerous computing applications running on host devices (e.g., a laptop computer, a desktop computer, a mobile phone, etc.) output audio to a user and allow a user to input audio such as user speech. Such computing applications include, for example, telephony and chat applications. Headsets are utilized in a variety of settings, and users may have one or more headsets or other audio devices for use with host devices.

Different headset designs may enhance the user experience in one way or another based on their primary intended use or combination of uses. For example, a headset may be optimized for comfort if the headset is to be used for an extended period of time, such as at a call center, whereas a different headset design may be optimized for wide frequency response in multimedia streaming applications. Wireless headsets are optimized for mobile use, whereas wired headsets are optimized for stationary use. For example, call centers often utilize wired headsets. Headsets optimized for call center use may have hearing protection features such as daily noise exposure limiting.

Wireless communications capable headsets (also referred to herein as “wireless capable headsets” or “wireless headsets”) communicate with a host device by sending and receiving radio frequency (RF) transmissions. Most modern host devices include an integrated wireless transceiver and antenna that operates in accordance with a common wireless communications standard, such as Bluetooth or DECT. However, a host device's integrated wireless hardware may provide a poor user experience when interfacing with a headset. For example, a host device's integrated wireless hardware may be incompatible with proprietary communications that can be sent to and/or received from a headset for configuring settings, controlling multimedia playback, and facilitating phone calls.

In the prior art, premium wireless headsets, such as unified communications (UC) headsets, are often sold with dedicated wireless dongles that provide for greater headset control and improved audio quality. However, the inventor has recognized that even with the use of prior art wireless dongles, the user experience is subpar if the user must operate the user interface on the wireless headset to control the headset or communicate control commands (e.g., media playback commands) to a host device.

In recent years, the number of computing applications running on host devices which utilize audio input and output has increased. Furthermore, shifting work patterns have blurred the line between work environments and home environments, and stationary use versus mobile use. As a result, users may wish to utilize a given headset design for multiple applications in multiple environments. Furthermore, the user may wish to quickly transition between headset types during an active communications session. As the variety of headsets and usage scenarios for host devices and headsets increase, there is a need for increased operational flexibility.

As such, improved methods and apparatuses for using headsets with host devices are required.

### BRIEF DESCRIPTION OF THE DRAWINGS

The present invention will be readily understood by the following detailed description in conjunction with the accompanying drawings, wherein like reference numerals designate like structural elements.

FIG. 1 illustrates an embodiment of an in-line dock in a schematic block diagram in example operation with a wireless capable headset.

FIG. 2 illustrates the in-line dock shown in FIG. 1 in a further example operation with the wireless capable headset.

FIG. 3 illustrates the in-line dock shown in FIG. 1 in a further operation with a wired headset and the wireless capable headset.

FIG. 4 shows a detailed perspective view of the in-line dock in one example.

FIG. 5 illustrates configuration of a pinout of active electrical connections in one example at a cable connector interface.

FIG. 6 illustrates processing elements for voice communications between the headset user and a remote call participant by the in-line dock according to one example.

FIGS. 7A-7B are a flow diagram illustrating a process for operating an in-line dock in one example.

FIG. 8 is a flow diagram illustrating a process for operating an in-line dock in a further example.

### DESCRIPTION OF SPECIFIC EMBODIMENTS

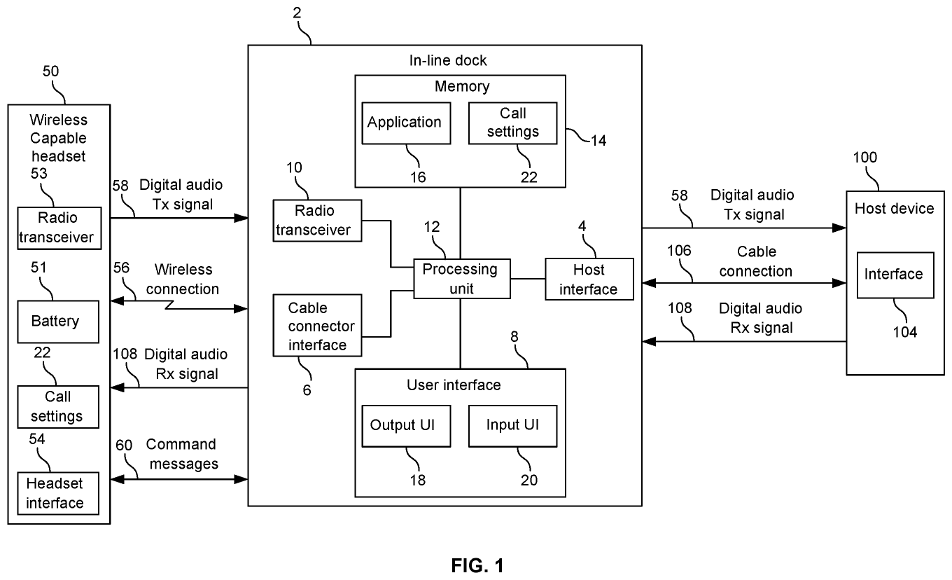

This invention relates to headset control and interfaces between headsets and host devices. In one example of the invention, an in-line dock includes a host interface, a cable connector interface for coupling a headset, a radio transceiver, and a user interface. FIG. 1 illustrates an embodiment of an in-line dock 2 in a schematic block diagram. In-line dock 2 provides a user interface for a wireless capable headset 50 and operates as an interface between a host device 100 and wireless capable headset 50. Host device 100 may, for example, be a laptop or desktop personal computer, smartphone, or tablet computer. Wireless capable headset 50 may, for example, be a Bluetooth headset or a Digital Enhanced Cordless Telecommunications (DECT) capable headset. In a further example, wireless capable headset 50 may be replaced with an alternative user audio device, such as a speakerphone having a loudspeaker and microphone.

In-line dock 2 includes a host interface 4 for connection to the host device 100 at an interface 104 to transfer digital audio data between the in-line dock 2 and the host device 100. For example, host interface 4 is a Universal Serial Bus (USB) Type A (“USB-A”) or Type C (“USB-C”) plug. Data transfer between in-line dock 2 and host device 100 is bidirectional, and data transfer between in-line dock 2 and wireless capable headset 50 is bidirectional. When in-line dock 2 is connected to the host device 100, in-line dock 2 enables the host device 100 to form a wireless or wired link with wireless capable headset 50. For example, host device 100 is connected to a communications network and may execute a videoconferencing application or VoIP application (also referred to as a softphone application) for a communications session with a remote call participant over the communications network, or may execute a multimedia application.

In-line dock 2 further includes a cable connector interface 6, a radio transceiver 10, and a user interface 8. For example, cable connector interface 6 is a USB-C interface, micro-USB interface, or USB-A interface. In various examples described herein, cable connector interface 6 is described as a USB-C interface providing analog signaling to and from a headset. Radio transceiver 10 provides for communications with a radio transceiver 53 at wireless capable headset 50. The radio transceiver 10 may communicate using any of various protocols known in the art for wireless connectivity. For example, radio transceiver 10 may communicate using Bluetooth, DECT, or IEEE 802.11 (WiFi) for access to a device or network. Where radio transceiver 10 is a Bluetooth communications transceiver, in-line dock 2 runs a Bluetooth stack optimized for audio performance.

Advantageously, user interface 8 allows for manual communication between the headset user and the wireless capable headset 50 using in-line dock 2. User interface 8 includes an input user interface 20 and an output user interface 18. User interface 8 can be any combinations of visual interfaces, tactile interfaces, and/or an audio interface that allow the user to input commands and receive output. Input user interface 20 may, for example, include input buttons for volume control, mute control, menu navigation, and call answer/end. Output user interface 18 may include, for example, one or more light emitting diodes for indicating a call status, volume level, and mute status.

In-line dock 2 includes a processing unit 12 operably connected to the host interface 4, the cable connector interface 6, the radio transceiver 10, memory 14, and the user interface 8. Processing unit 12 allows for processing data, in particular managing data between application program 16, the host interface 4, the cable connector interface 6, the radio transceiver 10, and the user interface 8. Processing unit 12 processes audio data, and sets up and manages communications between in-line dock 2 and wireless capable headset 50 and host device 100. In one example, processing unit 12 is a high performance, highly integrated, and highly flexible system-on-chip (SOC). Processing unit 12 may include a variety of processors (e.g., digital signal processors), with conventional CPUs being applicable. Processing unit 12 may operate as a controller that may include one or more processors, memory and firmware to perform functionality described herein. Processing unit 12 includes an analog-to-digital (ADC) converter used to convert analog audio streams to digital audio streams and a digital-to-analog (DAC) converter used to convert digital audio streams to analog audio streams as required to implement processes described herein. An audio encoder/decoder may be used for processing digital audio signals and analog audio signals as known in the art.

In-line dock 2 receives digital data from the host device and utilizes the on-board digital-to-analog (DAC) converter to convert the digital data to analog data and output the analog data through the cable connector interface 6. In-line dock 2 receives analog data through the cable connector interface 6 and utilizes the on-board analog-to-digital (ADC) converter to convert the analog data to digital audio for output to the host device 100. In outputting and receiving analog data at cable connector interface 6, in-line dock 2 adheres to the Audio Adapter Accessory Mode specification as set forth by the USB Implementers Forum (USB-IF) in the USB Type-C Specification.

Memory 14 may include a variety of memories, and in one example includes SDRAM, ROM, flash memory, or a combination thereof. Memory 14 may further include separate memory structures or a single integrated memory structure. In one example, memory 14 may be used to store passwords, network and telecommunications programs, and/or an operating system (OS). Memory 14 stores an application program 16 including computer-executable instructions which, when executed by the processing unit 12, operates the in-line dock 2 to perform operations described herein, such as during a voice communications call between a user of wireless capable headset 50 and a remote call participant. Although shown as a separate application, application program 16 may be integrated with the general operational firmware of in-line dock 2.

In the example operation shown in FIG. 1, wireless capable headset 50 is operating in a wireless mode during a voice communications call between the headset user and a remote call participant. In-line dock 2 receives over wireless connection 56 from a radio transceiver 53 at the wireless capable headset 50 a digital audio transmit (Tx) signal 58 at the radio transceiver 10 and outputs the digital audio transmit (Tx) signal 58 at the host interface 4 to the host device 100.

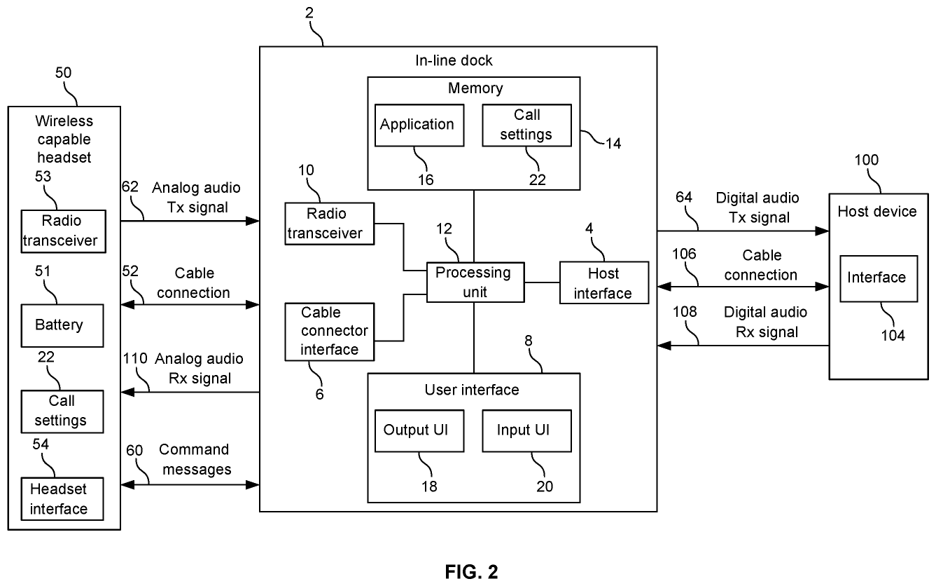

In-line dock 2 receives at the host interface 4 from the host device 100 over cable connection 106 a digital audio receive (Rx) signal 108 and transmits the digital audio receive (Rx) signal 108 from the radio transceiver 10 to the wireless capable headset 50. Application program 16 simultaneously provides an analog audio receive (Rx) signal 110 (shown in FIG. 2) to the cable connector interface 6 following digital-to-analog conversion of digital audio receive (Rx) signal 108.

In-line dock 2 transmits command messages 60 from the radio transceiver 10 to the wireless capable headset 50 and/or command messages to host device 100, the command messages 60 or command messages sent to host device 100 associated with input actions received at the user interface 8. For example, command messages 60 and command messages to host device 100 may change a call volume level, answer or end a call, place a call on hold, or place the call on mute.

In one example, radio transceiver 10 receives and transmits a wireless signal utilizing the Bluetooth protocol Hands-Free Profile. The wireless signal includes outbound audio and Hands-Free Profile digital command messages received from processing unit 12. Processing unit 12 is operable to receive user input commands from user interface 8 and convert these commands to Hands-Free Profile digital command messages.

In the example operation shown in FIG. 2, wireless capable headset 50 is operating in a wired connection mode during the voice communications call between the headset user and the remote call participant. The headset user connects wireless capable headset 50 to in-line dock 2 using cable connection 52 during the voice communications call. Cable connection 52 is a cable with a first male connector plug on one end which inserts into cable connector interface 6 at in-line dock 2 and a second male connector plug on the other end which inserts into a headset interface 54 at wireless capable headset 50. In-line dock 2 receives from the wireless capable headset 50 an analog audio transmit (Tx) signal 62 at the cable connector interface 6 through the cable connection 52. In this example, cable connector interface 6 is a USB-C interface. In-line dock 2 outputs a corresponding digital audio transmit (Tx) signal 64 at the host interface 4 to the host device 100. In-line dock 2 outputs analog audio receive (Rx) signal 110 through the cable connector interface 6 to the wireless capable headset 50. Advantageously, the use of analog audio receive (Rx) signal 110 and analog audio transmit (Tx) signal 62 allow the length of the cable connection 52 to be extended relative to the use of digital signaling. In one example, cable connection 52 is greater than 1.5 meters.

Once cable connection 52 is formed, the headset user may continue to use user interface 8 to control wireless capable headset 50. For example, in-line dock 2 outputs command messages 60 over cable connection 52 to the wireless capable headset 50 associated with input actions received at the user interface 8. In-line dock 2 provides charging power through the cable connector interface 6 to a battery 51 of the wireless capable headset 50.

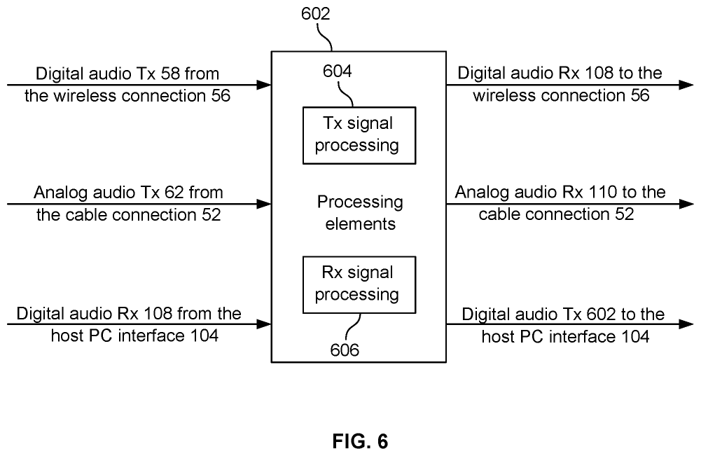

In one example operation, wireless connection 56 (shown in FIG. 1) remains active and in use following formation of cable connection 52 such that both wireless connection 56 and cable connection 52 are concurrent. For example, in-line dock 2 continues to output command messages 60 over wireless connection 56 following formation of cable connection 52. FIG. 6 illustrates processing elements 602 for voice communications between the headset user and a remote call participant by in-line dock 2 where both wireless connection 56 and cable connection 52 are concurrent. Processing elements 602 may be implemented in hardware, software, or combinations thereof. Processing elements 602 may be implemented as one or more digital signal processors or one or more integrated circuits, and include analog-to-digital converter elements and digital-to-analog converter elements. Processing elements 602 receive (1) digital audio transmit (Tx) signal 58 from wireless connection 56, (2) analog audio transmit (Tx) signal 62 from cable connection 52, and (3) digital audio receive (Rx) signal 108 from host device 100 interface 104.

Processing elements 602 include Tx signal processing 604 and Rx signal processing 606. Tx signal processing 604 may include correlation of the digital audio transmit (Tx) signal 58 and the analog audio transmit (Tx) signal 62 to calculate a dropping or a smoothing of samples output to interface 104 of the host device 100. Rx signal processing 606 may include calculation of a time delay to add to the analog audio receive (Rx) signal 110, the time delay added to synchronize the digital audio receive (Rx) signal 108 and the analog audio receive (Rx) signal 110. Processing elements 602 may perform various audio processing, including noise suppression, echo cancellation, volume detection and control, equalization, and sample rate conversion. Processing elements 602 output (1) digital audio receive (Rx) signal 108 to wireless connection 56, (2) analog audio receive (Rx) signal 110 to cable connection 52, and (3) digital audio transmit (Tx) signal 608 to host device 100 interface 104.

Advantageously, an improved user experience is provided when switching between wired and wireless use, allowing the user the freedom to unplug wireless capable headset 50 at any time to roam freely during an active call. Once cable connection 52 is disconnected, in-line dock 2 reverts to operation described above in reference to FIG. 1. Application program 16 determines the connection state of wireless capable headset 50 to in-line dock 2.

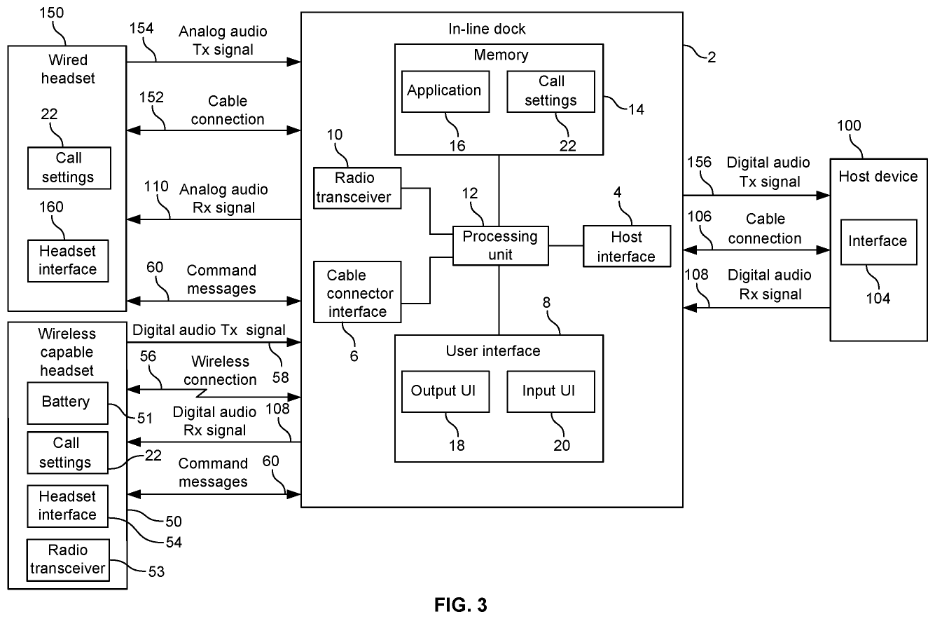

FIG. 3 illustrates in-line dock 2 in operation with a wired headset 150 and wireless capable headset 50 during a voice communications call. For example, wireless capable headset 50 is of the type Voyager 8200 UC or similar and wired headset 150 is a wired USB-C headset of the type Blackwire 7225 or similar, both available from Poly (formerly Plantronics, Inc.), Santa Cruz, CA, USA. In one example, a headset user is on a voice communications call using wireless capable headset 50 operating in a wireless connection mode as described above in reference to FIG. 1, and desires to switch use to wired headset 150 (or vice versa). Once the user takes the action to either plug or unplug cable connection 152 coupled to wired headset 150, in-line dock 2 intelligently switches between the analog audio pass-through of wired headset 150 and the wireless audio to the wireless capable headset 50.

Following formation of cable connection 152 between headset interface 160 and cable connector interface 6, in-line dock 2 receives from wired headset 150 an analog audio transmit (Tx) signal 154 at the cable connector interface 6. In-line dock 2 outputs a corresponding digital audio transmit (Tx) signal 156 at the host interface 4 to the host device 100. In-line dock 2 outputs the analog audio receive (Rx) signal 110 at the cable connector interface 6 to the wired headset 150.

Advantageously, in-line dock 2 synchronizes one or more call settings 22 at wired headset 150 established at wireless capable headset 50 prior to formation of the cable connection 152 by outputting any necessary call setting command message to wired headset 150. Call settings 22 are stored in memory 14 at in-line dock 2, wireless capable headset 50, and wired headset 150 so that application program 16 can synchronize one or more call settings at the wireless capable headset 50 and wired headset 150. The user experience when transitioning from wireless capable headset 50 to wired headset 150 is therefore seamless. For example, the one or more call settings 22 include a volume level, a mute status, or a hold status.

In a further example operation, in-line dock 2 utilizes wireless connection 56 and cable connection 152 concurrently. Advantageously, the user may transition from use of wired headset 150 to wireless capable headset 50 or vice versa during a voice communication call without the need to unplug or plug cable connection 152 of the wired headset 150. In-line dock 2 receives over wireless connection 56 from radio transceiver 53 at the wireless capable headset 50 a digital audio transmit (Tx) signal 58. In-line dock 2 receives at the host interface 4 from the host device 100 a digital audio receive (Rx) signal 108. In-line dock 2 transmits the digital audio receive (Rx) signal 108 to the wireless capable headset 50, and simultaneously outputs a corresponding analog audio receive (Rx) signal 110 at cable connector interface 6 to wired headset 150.

In-line dock 2 receives from wired headset 150 an analog audio transmit (Tx) signal 154 at the cable connector interface 6, the digital audio transmit (Tx) signal 58 and the analog audio transmit (Tx) signal 154 received concurrently. In-line dock 2 outputs a digital audio transmit (Tx) signal 156 at the host interface 4 to the host device 100. In-line dock 2 transmits command messages 60 from the radio transceiver 10 to the wireless capable headset 50 and outputs command messages 60 at the cable connector interface 6 to the wired headset 150, the command messages 60 associated with input actions received at the user interface 8. In this manner, call settings at wireless capable headset 50 and wired headset 150 are synchronized, improving the user experience when transitioning between headset types.

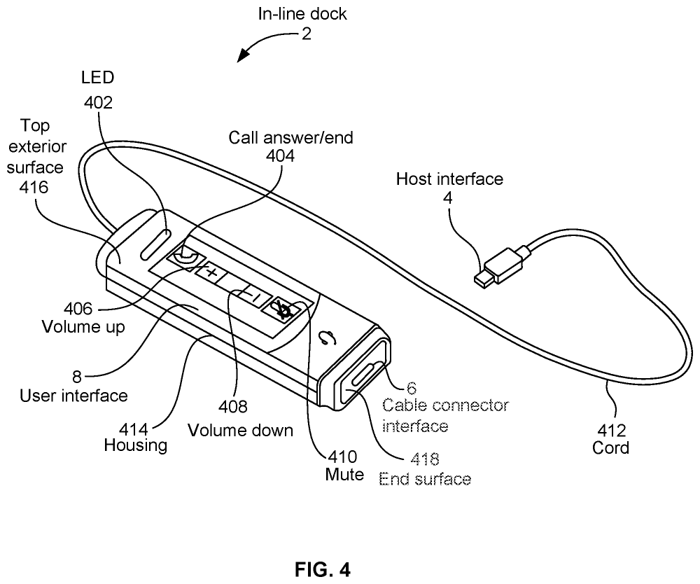

FIG. 4 shows a detailed perspective view of the in-line dock 2 in one example. In-line dock 2 includes a cord 412. Cord 412 includes wiring compliant with a USB standard, and includes host interface 4, which in this example is a USB-C plug. In further examples, different plug and wiring configurations may be used. In-line dock 2 includes a housing 414 having a top exterior surface 416 on which elements of user interface 8 are accessible to the headset user. In this example, user interface 8 includes an LED 402, call answer/end button 404, volume up button 406, volume down button 408, and mute button 410. Housing 414 includes an end surface 418 on which cable connector interface 6 is exposed. Depending on its color and whether it is flashing or solid, LED 402 may indicate one or more of the following call states: incoming call, active call, muted call, call on hold, or idle.

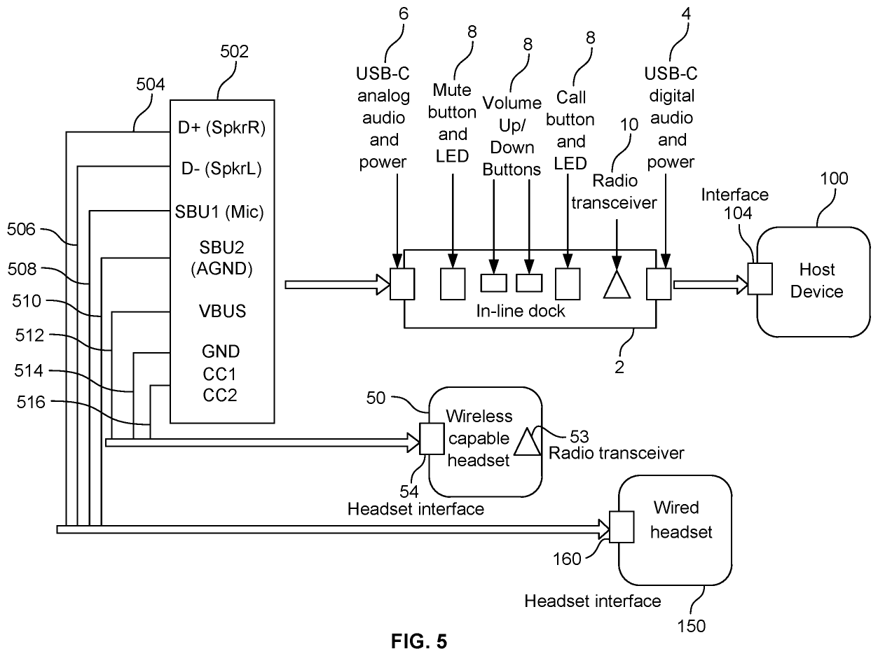

FIG. 5 illustrates configuration of a pinout 502 of active electrical connections in one example at cable connector interface 6 for an electrical circuit at wireless capable headset 50 where cable connector interface 6 is a USB-C interface, and an electrical circuit at wired headset 150 for transfer of audio data and device charging power in Audio Adapter Accessory Mode. In the example shown in FIG. 5, wired headset 150 is a wired USB-C headset. Wired headset 150 connects with contact D+(SpkrR) 504, D-(SpkrL) 506, SBU1 (Mic) 508, and SBU2 (AGND) 510 to establish electrical interconnection between headset interface 160 and cable connector interface 6. Wireless capable headset 50 includes contacts to interconnect with VBUS 512, GND 514, and CC1/CC2 516 to establish electrical interconnection between headset interface 54 and cable connector interface 6. Wired headset 150 also supports interconnection with VBUS 512, GND 514, and CC1/CC2 516 for a connection to host device 100. Similarly, wireless capable headset 50 may also support interconnection with D+(SpkrR) 504, D-(SpkrL) 506, SBU1 (Mic) 508, and SBU2 (AGND) 510 for audio data transfer and VBUS 512, GND 514, and CC1/CC2 516 for 500 mA device charging power. In the example shown in FIG. 5, user interface 8 includes a mute button and LED, volume up and down buttons, and a call button and LED. Radio transceiver 10 is a Bluetooth or DECT radio. Cable connector interface 6 provides for analog audio data transfer and power. Host interface 4 is a USB-C interface and provides for digital audio data transfer and power.

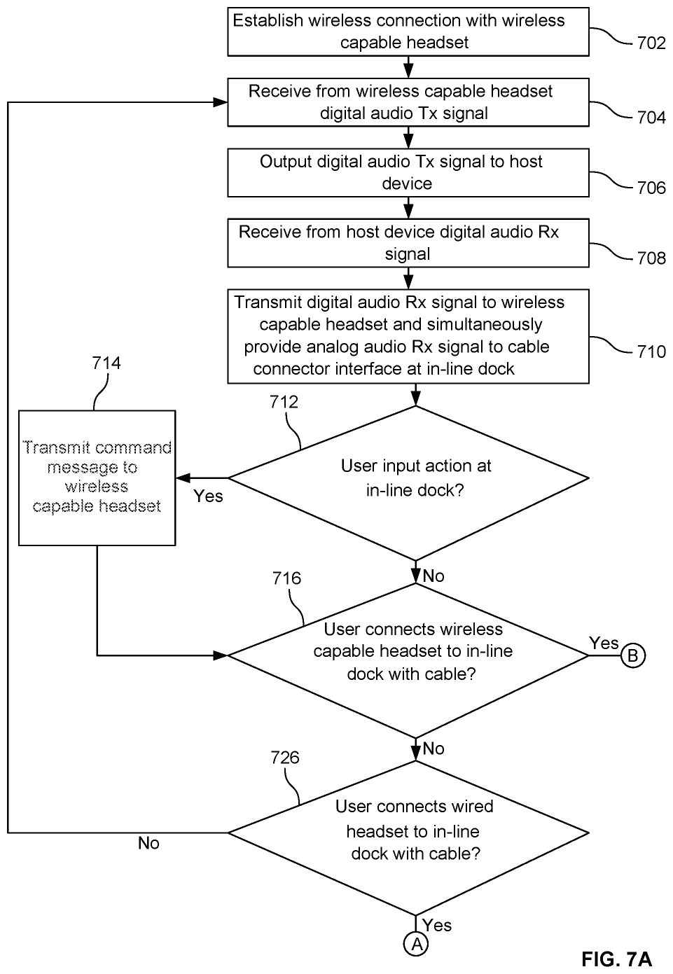

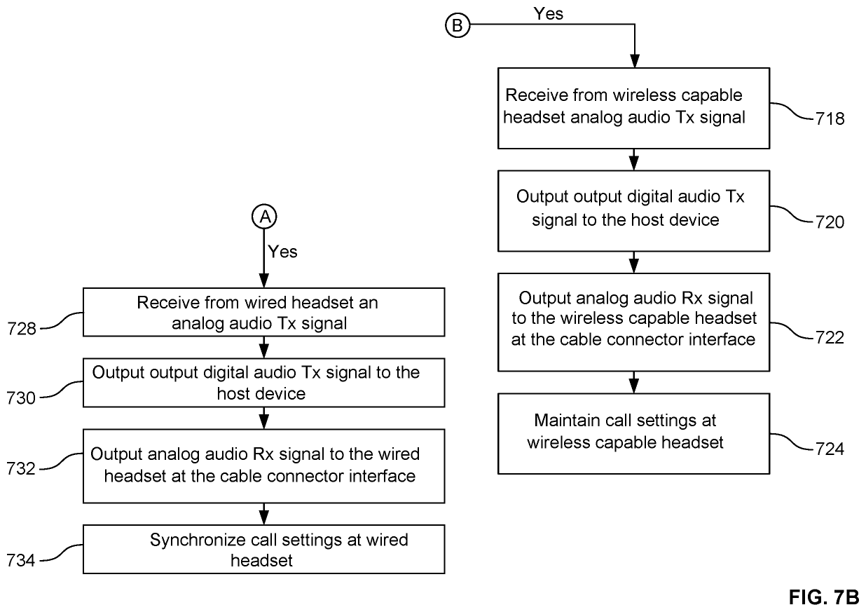

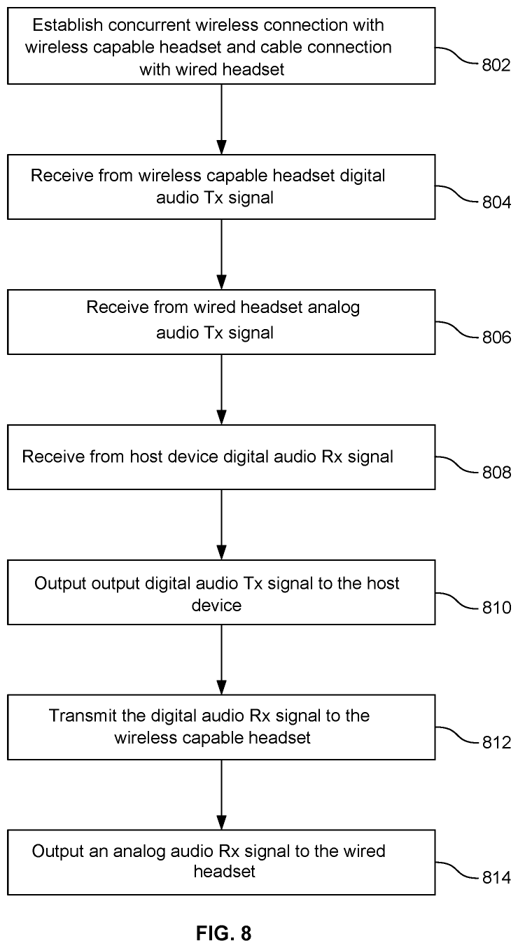

In various embodiments, the techniques of FIGS. 7A-7B and FIG. 8 discussed below may be implemented as sequences of instructions executed by one or more electronic systems. For example, one or more electronic systems as shown in FIGS. 1-3 are utilized. The instructions may be stored by the in-line dock 2 or the instructions may be received by the in-line dock 2 (e.g., via a network connection).

FIGS. 7A-7B are a flow diagram illustrating a process for operating an in-line dock in one example. At block 702, a wireless connection with a wireless capable headset is established. At block 704, a digital audio transmit (Tx) signal is received at a radio transceiver from the wireless capable headset during a voice communications call. At block 706, the digital audio transmit (Tx) signal is output at a host interface to a host device.

At block 708, a digital audio receive (Rx) signal is received at the host interface from the host device. At block 710, the digital audio receive (Rx) signal is transmitted from a radio transceiver to the wireless capable headset and an analog audio receive (Rx) signal is output to a cable connector interface. In the example shown in FIGS. 7A-7B, the cable connector interface is a USB-C interface. In one example, the transmission of the digital audio receive (Rx) signal and the output of the analog audio receive (Rx) signal occur simultaneously. In one example, the radio transceiver is a Bluetooth transceiver and the wireless capable headset is a Bluetooth headset. In a further example, the radio transceiver is a DECT transceiver and the wireless capable headset is a DECT headset.

At decision block 712, it is determined whether there has been a user input action at a user interface at the in-line dock. In one example, the user interface includes input buttons for volume control, mute control, and call answer/end. The user interface also includes an output user interface including one or more light emitting diodes.

If no at decision block 712, the process proceeds to decision block 716. If yes at decision block 712, at block 714, a command message is transmitted from the radio transceiver at the in-line dock to the wireless capable headset, where the command message is associated with the input action received at the user interface. Following block 714, the process proceeds to decision block 716.

At decision block 716, it is determined whether the user connects the wireless capable headset to the in-line dock at a cable connector interface with a cable (e.g., USB-C cable). If yes at decision block 716, the process proceeds to block 718. At block 718, an analog audio transmit (Tx) signal is received from the wireless capable headset at the cable connector interface. At block 720, an output digital audio transmit (Tx) signal is output at the host interface to the host device. At block 722, the analog audio receive (Rx) signal is output at the cable connector interface to the wireless capable headset.

At block 724, a call setting at the wireless capable headset established prior to the cable connection of the wireless capable headset to the cable connector interface is maintained following the cable connection. In one example, the call setting is a volume level or a mute status. In one example, charging power is provided at the cable connector interface to a battery at the wireless capable headset following the cable connection. In one example, a second command message is output to the wireless capable headset at the cable connector interface following the cable connection, the second command message associated with a second input action received at the user interface at the in-line dock. In one example, the wireless connection between the wireless capable headset and the in-line dock remains active following the cable connection such that outputting the analog audio receive (Rx) signal at the cable connector interface (block 722) occurs concurrently with transmitting the digital audio receive (Rx) signal to the wireless capable headset (block 710).

If no at decision block 716, the process proceeds to decision block 726. At decision block 726, it is determined whether the user connects a wired headset to the in-line dock with a cable (e.g., a USB-C cable). In the example shown in FIGS. 7A-7B, the wired headset is a wired USB-C headset. If no at decision block 726, the process returns to block 704.

If yes at decision block 726, the process proceeds to block 728. At block 728, an analog audio transmit (Tx) signal is received from the wired headset at the cable connector interface. At block 730, an output digital audio transmit (Tx) signal is output at the host interface to the host device. At block 732, the analog audio receive (Rx) signal is output at the cable connector interface to the wired headset. At block 734, call settings at the wired headset are synchronized with call settings at the wireless capable headset. In one example, the call settings include a volume level or a mute status.

FIG. 8 is a flow diagram illustrating a process for operating an in-line dock in a further example. At block 802, a wireless connection is established with a wireless capable headset and a cable connection is established with a wired headset, where the wireless connection and the cable connection are concurrent. At block 804, a digital audio transmit (Tx) signal is received from the wireless capable headset at a radio transceiver. At block 806, an analog audio transmit (Tx) signal is received from the wired headset at a cable connector interface, where the digital audio transmit (Tx) signal and the analog audio transmit (Tx) signal are received concurrently. In the example shown in FIG. 8, the wired headset is a wired USB-C headset and the cable connector interface is a USB-C interface.

At block 808, a digital audio receive (Rx) signal is received at a host interface from the host device. At block 810, an output digital audio transmit (Tx) signal is output at the host interface to the host device. At block 812, the digital audio receive (Rx) signal is transmitted from the radio transceiver to the wireless capable headset. At block 814, an analog audio receive (Rx) signal is output at the cable connector interface to the wired headset. In one example, outputting the analog audio receive (Rx) signal occurs concurrently with transmitting the digital audio receive (Rx) signal from the radio transceiver to the wireless capable headset. In one example, a command message is transmitted from the radio transceiver to the wireless capable headset and the command message is output at the cable connector interface to the wired headset, where the command message is associated with an input action received at the user interface.

In one example embodiment of the invention, an in-line dock includes a host interface for connection to a host device to transfer digital data between the apparatus and the host device, a cable connector interface, and one or more user interfaces configured to receive an input action. The in-line dock includes a radio transceiver configured to transmit a command message to a wireless capable headset, the command message associated with the input action. The in-line dock further includes one or more processors operably connected to the host interface, the cable connector interface, the one or more user interfaces, and the radio transceiver. The in-line dock further includes one or more memories operably connected to the one or more processors.

In one example embodiment of the invention, a method includes receiving at a host interface of an apparatus from a host device a digital receive (Rx) signal. The method includes transmitting a first receive (Rx) signal from a radio transceiver of the apparatus to a wireless capable headset and providing a second receive (Rx) signal to a cable connector interface of the apparatus. The method further includes receiving an input action at one or more user interfaces of the apparatus, and transmitting a command message from the radio transceiver to the wireless capable headset, the command message associated with the input action received at the one more user interfaces.

In one example embodiment of the invention, an in-line dock includes a host interface for connection to a host device to transfer digital audio data between the apparatus and the host device, one or more user interfaces configured to receive an input action, and a radio transceiver configured to transmit a command message to a wireless capable headset, the command message associated with the input action. The in-line dock further includes a cable connector interface configured to output the command message to a wired headset. The in-line dock includes one or more processors operably connected to the host interface, the one or more user interfaces, the radio transceiver, and the cable connector interface. The in-line dock further includes one or more memories operably connected to the one or more processors.

In one example embodiment of the invention, an in-line dock includes a host interface for connection to a host device to transfer digital audio data between the in-line dock and the host device, a USB-C interface, a radio transceiver, and one or more user interfaces. The in-line dock includes one or more processors operably connected to the host interface, the USB-C interface, the radio transceiver, and the one or more user interfaces. The in-line dock further includes one or more memories operably connected to the one or more processors, where the one or more memories include computer-executable instructions stored thereon which, when executed by the one or more processors, cause the one or more processors to perform operations during a voice communications call between a user of a wireless capable headset and a remote call participant (also referred to as a “far end call participant”).

The operations include receiving from the wireless capable headset a digital audio transmit (Tx) signal at the radio transceiver, and outputting the digital audio transmit (Tx) signal at the host interface to the host device. The operations include receiving at the host interface from the host device a digital audio receive (Rx) signal. The operations further include transmitting the digital audio receive (Rx) signal from the radio transceiver to the wireless capable headset and providing an analog audio receive (Rx) signal to the USB-C interface. The operations include receiving an input action at the one or more user interfaces, and transmitting a command message from the radio transceiver to the wireless capable headset. The command message is associated with the input action received at the one more user interfaces.

In one example, the operations further include receiving from the wireless capable headset an analog audio transmit (Tx) signal at the USB-C interface following a cable connection of the wireless capable headset to the USB-C interface during the voice communications call, and outputting an output digital audio transmit (Tx) signal at the host interface to the host device. The analog audio receive (Rx) signal is output at the USB-C interface to the wireless capable headset following the cable connection of the wireless capable headset to the USB-C interface during the voice communications call. A call setting is maintained at the wireless capable headset established prior to the cable connection. In one example, the wireless connection between the wireless capable headset and the in-line dock remains active following the cable connection such that outputting the analog audio receive (Rx) signal at the USB-C interface to the wireless capable headset occurs concurrently with transmitting the digital audio receive (Rx) signal from the radio transceiver to the wireless capable headset.

In one example embodiment of the invention, an in-line dock includes a host interface for connection to a host device to transfer digital audio data between the in-line dock and the host device, a USB-C interface, a radio transceiver, and one or more user interfaces. The in-line dock includes one or more processors operably connected to the host interface, the USB-C interface, the radio transceiver, and the one or more user interfaces. The in-line dock further includes one or more memories operably connected to the one or more processors, where the one or more memories include computer-executable instructions stored thereon which, when executed by the one or more processors, cause the one or more processors to perform operations during a voice communications call between a user of a wireless capable headset and a wired USB-C headset and a remote call participant.

The operations including establishing a wireless connection with the wireless capable headset and a cable connection with the wired USB-C headset, where the wireless connection and the cable connection are concurrent. The operations include receiving from the wireless capable headset a digital audio transmit (Tx) signal at the radio transceiver. The operations further include receiving from the wired USB-C headset an analog audio transmit (Tx) signal at the USB-C interface, where the digital audio transmit (Tx) signal and the analog audio transmit (Tx) signal are received concurrently. The operations include receiving at the host interface from the host device a digital audio receive (Rx) signal, and outputting an output digital audio transmit (Tx) signal at the host interface to the host device. The operations include transmitting the digital audio receive (Rx) signal from the radio transceiver to the wireless capable headset, and outputting an analog audio receive (Rx) signal at the USB-C interface to the wired USB-C headset.

In one example embodiment of the invention, a method includes receiving from a wireless capable headset during a voice communications call a digital audio transmit (Tx) signal at a radio transceiver, and outputting the digital audio transmit (Tx) signal at a host interface to a host device. The method includes receiving at the host interface from the host device a digital audio receive (Rx) signal. The method further includes transmitting the digital audio receive (Rx) signal from the radio transceiver to the wireless capable headset and providing an analog audio receive (Rx) signal to a USB-C interface. The method includes receiving an input action at one or more user interfaces, and transmitting a command message from the radio transceiver to the wireless capable headset. The command message is associated with the input action received at the one more user interfaces.

In one example embodiment of the invention, an in-line dock provides desktop controls and visibility for Mute/Volume/Call status for wireless capable headsets, such as Bluetooth (BT) or Digital Enhanced Cordless Telecommunications (DECT) headsets. The in-line dock provides seamless handoff between Universal Serial Bus (USB) analog pass-through and a Bluetooth or DECT (BT/DECT) wireless connection.

The in-line dock extends the capabilities of prior art BT/DECT dongles and can be offered as a separate accessory in a call center or office environment that remains attached to a host device such as a desktop PC. The in-line dock provides an audio headset dock to the user when moving between working from home and the office. The in-line dock provides BT/DECT wireless connectivity, a USB-C port for charging for BT/DECT wireless headsets, and analog audio pass-through via USB-C. The in-line dock provides audio processing of analog audio pass-through. The in-line dock includes Mute/Volume/Call button controls and status LEDs. The in-line dock further provides for extended cord length when connecting a headset over USB-C.

In a first example embodiment utilizing a cable connection, a user of a wireless headset (e.g., a BT/DECT headset) attaches a USB-C cable to the wireless headset and the in-line dock. Upon doing this, the in-line dock provides charging power to the wireless headset and transitions from wireless communications to analog audio pass-through if available via USB-C Audio Accessory Mode. Mute/Volume/Call status continues to persist following the cable connection. In one example, the wireless headset is Bluetooth paired with the in-line dock upon attachment of the USB-C cable to the headset and the in-line dock.

In a second example embodiment utilizing a wireless connection, the user of a wireless headset pairs the wireless headset to the in-line dock over wireless technologies. Upon doing this, the in-line dock provides BT/DECT connectivity to the wireless headset and the current Mute/Volume/Call status is shown on the in-line dock. The button presses on the in-line dock control the wireless headset wirelessly.

The host PC USB-C port maintains a single USB Audio device regardless of the type of headset connected. This provides a consistent and reliable USB Audio endpoint that does not change when switching between a wired headset and a wireless headset, and it also provides a consistent user interface that does not change based on the type of headset connected. Once the user configures their PC default audio device and softphone to select the in-line dock, it will remain the same for its extended use with multiple headsets, and the Call/Mute indication and Volume setting will not change when switching between headsets.

To accomplish this, the in-line dock synchronizes the current Mute/Volume/Call state to the connected wireless or wired headset and maintains an active uninterrupted audio stream to the host PC regardless of the headset connection state. Once the user takes the action to either plug or unplug a cable connection, the in-line dock intelligently switches between the analog audio pass-through of the wired headset and the wireless audio to the wireless headset. In the case where the cable connection is made simply for charging the battery of the wireless headset, the in-line dock maintains the wireless connection and is capable of detecting whether the analog audio pass-through is available.

In the case where the wireless headset supports both the first example embodiment utilizing a cable connection and the second example embodiment utilizing a wireless connection, the user may decide to plug-in their wireless headset to the in-line dock while they are sitting at their desk and maintain the freedom to unplug their wireless headset at any time to roam freely and use it wirelessly. The in-line dock maintains an uninterrupted audio stream to provide a smooth user experience between the wired and wireless connections. In order to accomplish this, a digital signal processing (DSP) algorithm running on the in-line dock has inputs from both the analog audio Tx of the cable connection and the digital audio Tx of the wireless connection. The DSP algorithm outputs a single digital audio Tx to the host PC USB-C audio device, and is responsible for dropping or adding samples to support the seamless transition between the cable and wireless connections. The audio Rx is sent to both the wireless and wired connections simultaneously, accounting for the appropriate delays in order to synchronize the audio playback when a headset unplug/replug transition occurs. Advantageously, the in-line dock provides an improved user experience, giving users more desktop capabilities and seamless transition between mobile and desktop use.

The preceding description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein.

Block diagrams of example systems are illustrated and described for purposes of explanation. The functionality that is described as being performed by a single system component may be performed by multiple components. Similarly, a single component may be configured to perform functionality that is described as being performed by multiple components. For purpose of clarity, details relating to technical material that is known in the technical fields related to the invention have not been described in detail so as not to unnecessarily obscure the present invention. It is to be understood that various example of the invention, although different, are not necessarily mutually exclusive. Thus, a particular feature, characteristic, or structure described in one example embodiment may be included within other embodiments unless otherwise noted.

While the exemplary embodiments of the present invention are described and illustrated herein, it will be appreciated that they are merely illustrative and that modifications can be made to these embodiments without departing from the spirit and scope of the invention. As used herein, the term “headset” includes any type of audio device capable of being worn on a user head. As used herein, the term “voice communications call” includes any type of communications session involving voice, including those utilizing video. Acts described herein may be computer readable and executable instructions that can be implemented by one or more processors and stored on a computer readable memory or articles. The computer readable and executable instructions may include, for example, application programs, program modules, routines and subroutines, a thread of execution, and the like. In some instances, not all acts may be required to be implemented in a methodology described herein.

Terms such as “component”, “module”, “circuit”, and “system” are intended to encompass software, hardware, or a combination of software and hardware. For example, a system or component may be a process, a process executing on a processor, or a processor. Furthermore, a functionality, component or system may be localized on a single device or distributed across several devices. The described subject matter may be implemented as an apparatus, a method, or article of manufacture using standard programming or engineering techniques to produce software, firmware, hardware, or any combination thereof to control one or more computing devices.

Thus, the scope of the invention is intended to be defined only in terms of the following claims as may be amended, with each claim being expressly incorporated into this Description of Specific Embodiments as an embodiment of the invention.

What is claimed is:

1. An apparatus comprising:
a host interface for connection to a host device to transfer digital data between the apparatus and the host device;
a cable connector interface;
one or more user interfaces;
a radio transceiver configured for communications with a wireless capable headset;
one or more processors operably connected to the host interface, the cable connector interface, the one or more user interfaces, and the radio transceiver; and
one or more memories operably connected to the one or more processors, wherein the apparatus is configured for communications utilizing the cable connector interface with one selected from the wireless capable headset and a wired headset.

2. The apparatus of claim 1, wherein the one or more user interfaces are configured to receive an input action and the radio transceiver is configured to transmit a command message to the wireless capable headset, the command message associated with the input action.

3. The apparatus of claim 2, wherein the radio transceiver comprises a Bluetooth transceiver and the wireless capable headset comprises a Bluetooth headset.

4. The apparatus of claim 1, wherein the host interface is configured to receive from the host device a digital receive (Rx) signal, the radio transceiver is further configured to transmit a first receive (Rx) signal, and the cable connector interface is configured to output a second receive (Rx) signal.

5. The apparatus of claim 4, wherein the first receive (Rx) signal comprises a digital audio receive (Rx) signal and the second receive (Rx) signal comprises an analog audio receive (Rx) signal.

6. The apparatus of claim 4, wherein the radio transceiver and the cable connector interface are configured to concurrently transmit the first receive (Rx) signal and output the second receive (Rx) signal.

7. The apparatus of claim 1, wherein the one or more user interfaces comprise:
an input user interface comprising input buttons for volume control, mute control, and call answer; and
an output user interface comprising one or more light emitting diodes.

8. The apparatus of claim 1, wherein the cable connector interface comprises a USB-C interface.

9. The apparatus of claim 1, wherein the cable connector interface is configured to output a command message to the wireless capable headset, the command message associated with an input action received at the one more user interfaces.

10. A method comprising:
receiving at a host interface of an apparatus from a host device a digital receive (Rx) signal;
transmitting a first receive (Rx) signal from a radio transceiver of the apparatus to a wireless capable headset and providing a second receive (Rx) signal to a cable connector interface of the apparatus;
receiving an input action at one or more user interfaces of the apparatus; and
transmitting a command message from the radio transceiver to the wireless capable headset, the command message associated with the input action received at the one more user interfaces.

11. The method of claim 10, wherein the first receive (Rx) signal comprises a digital audio receive (Rx) signal and the second receive (Rx) signal comprises an analog audio receive (Rx) signal.

12. The method of claim 10, further comprising:
receiving from the wireless capable headset a transmit (Tx) signal at the cable connector interface following a cable connection of the wireless capable headset to the cable connector interface, and outputting an output transmit (Tx) signal at the host interface to the host device; and
outputting the second receive (Rx) signal at the cable connector interface to the wireless capable headset.

13. The method of claim 10, further comprising synchronizing the first receive (Rx) signal and the second receive (Rx) signal by adding a time delay to the second receive (Rx) signal.

14. The method of claim 10, further comprising outputting the second receive (Rx) signal at the cable connector interface to a wired headset concurrently with transmitting the first receive (Rx) signal from the radio transceiver of the apparatus to the wireless capable headset.

15. The method of claim 10, further comprising synchronizing a call setting between a wired headset coupled to the cable connector interface and the wireless capable headset.

16. The method of claim 15, wherein the call setting comprises a volume level or a mute status.

17. An apparatus comprising:
a host interface for connection to a host device to transfer digital audio data between the apparatus and the host device;
one or more user interfaces configured to receive an input action;
a radio transceiver configured to transmit a command message to a wireless capable headset, the command message associated with the input action;
a cable connector interface configured to output the command message to a wired headset;
one or more processors operably connected to the host interface, the one or more user interfaces, the radio transceiver, and the cable connector interface; and
one or more memories operably connected to the one or more processors.

18. The apparatus of claim 17, wherein the host interface is configured to receive from the host device a digital receive (Rx) signal, the radio transceiver is further configured to transmit a first receive (Rx) signal to the wireless capable headset, and the cable connector interface is configured to concurrently output a second receive (Rx) signal to the wired headset.

19. The apparatus of claim 17, wherein the cable connector interface comprises a USB-C interface and the radio transceiver comprises a Bluetooth transceiver.

20. The apparatus of claim 17, wherein the host interface is configured to receive from the host device a digital receive (Rx) signal, the radio transceiver is further configured to transmit a first receive (Rx) signal, and the cable connector interface is configured to output a second receive (Rx) signal.
